(19) United States
(12) Patent Application Publication
(10) Pub. No.: US 2020/0068658 A1
(43) Pub. Date: Feb. 27, 2020

(54) COMMUNICATION CONFIGURATION METHOD OF ELECTRONIC DEVICE, AND DEVICE THEREOF

(71) Applicant: Samsung Electronics Co., Ltd., Suwon-si, Gyeonggi-do (KR)

(72) Inventor: Kang Min LEE, Hwaseong-si (KR)

(21) Appl. No.: 16/487,411

(22) PCT Filed: Feb. 14, 2018
(86) PCT No.: PCT/KR2018/001916

§ 371 Date: Aug. 20, 2019

(30) Foreign Application Priority Data
Feb. 20, 2017 (KR) 10-2017-0022407

(51) Int. Cl. H04W 88/06; H04W 4/80; H04W 48/08; H04W 12/04

(52) U.S. Cl. CPC H04W 88/06; H04W 12/04; H04W 48/08; H04W 4/80

(57) ABSTRACT

An electronic device is disclosed. The disclosed electronic device comprises: a communication module for communicating with a server, a device, and an access point (AP); a memory for storing identification information of the access point and account information on the server; and a processor electrically connected with the communication module and the memory, wherein the processor searches for the device through the communication module, connects with the searched for device, and can transmit the identification information of the access point and the account information to the connected device.

### CROSS-REFERENCE TO RELATED APPLICATIONS

This application is a 371 National Stage of International Application No. PCT/KR2018/001916, filed Feb. 14, 2018, which claims priority to Korean Patent Application No. 10-2017-0022407, filed Feb. 20, 2017, the disclosures of which are herein incorporated by reference in their entirety.

### BACKGROUND

### 1. Field

Embodiments of the disclosure relate to a method for setting up communication in an electronic device.

### 2. Description of Related Art

With the development of communication and semiconductor technologies, various electronic devices equipped with communication modules are wirelessly connected to a server to form a network.

Various devices may be wirelessly connected to the server via an access point (AP). There is required a process of setting up a communication connection so as for each device to be connected to an AP.

### SUMMARY

To connect a device to an AP, the device may need to input identification information (ID) of the AP (for example, the SSID and password of the AP), and a separate physical button may be needed to facilitate connection setup.

Meanwhile, when the AP is changed or the device is disconnected from the AP, connection setup operation may need to be performed again so as for the device to be reconnected to the AP. When there are many devices connected to the same AP, it may be difficult to repeatedly set up the AP connection the number of times equal to the number of devices which had connected to the AP so as to recover or update connection information between the devices and the AP.

In particular, when the device supports only a single communication channel, such as Wi-Fi or Bluetooth, it may be very cumbersome to carry out physical operation and repeated connection setup tasks in the device.

An aspect of the disclosure is to provide a method and a device which allow a peripheral device around an electronic device to be easily connected to an AP and to be connected to a server via the AP, using the electronic device.

In accordance with an aspect of the disclosure, an electronic device includes a communication module that performs communication with a server, a peripheral device, and an access point, a memory that stores identification information of the access point and account information for the server, and a processor electrically connected to the communication module and the memory, wherein the processor searches for the peripheral device via the communication module, connects to the found peripheral device, and transmits the identification information of the access point and the account information to the connected peripheral device.

The processor may receive information indicating that connection between the server and the peripheral device is broken, from the server, request a key code containing identification information of the peripheral device from the server based on the received information, receive the key code from the server, and broadcast the identification information of the peripheral device contained in the key code.

The identification information of the access point may include at least one of an SSID and a password of the access point.

The identification information of the peripheral device may include at least one of an SSID and a password of the peripheral device.

The electronic device may use the key code as an SSID and a password of the electronic device.

The processor may connect to the peripheral device based on the key code and transmit identification information of a new access point different from the access point and the account information to the peripheral device.

In accordance with another aspect of the disclosure, a device includes a communication module that communicates with an electronic device and an access point, and a processor electrically connected to the communication module, wherein the processor may receive identification information of the access point from the electronic device, connect to the access point based on the identification information of the access point, and transmit identification information of the device to the access point.

The processor may receive account information from the electronic device, and connect to a server via the access point using the account information.

The device may further include a memory electrically connected to the processor, and the processor may receive a key code containing the identification information of the device from the electronic device and store the key code in the memory.

In accordance with another aspect of the disclosure, a method for performing communication connection in an electronic device, includes storing identification information of an access point and account information for connecting to a server in a memory of the electronic device, searching for a peripheral device around the electronic device via a communication module of the electronic device, connecting the electronic device to the found peripheral device, and transmitting the identification information of the access point and the account information to the connected peripheral device.

The method may further include receiving information indicating that connection with the peripheral device is broken from the server, requesting a key code containing identification information of the peripheral device from the server based on the received information, receiving the key code from the server, and broadcasting the identification information of the peripheral device contained in the key code.

The key code may be used as an SSID and a password of the electronic device.

The method may further include connecting to the peripheral device based on the key code and transmitting identification information of a new access point different from the access point and the account information to the peripheral device.

According to the various embodiments disclosed in the disclosure, it is possible to allow a device around an electronic device to be easily connected to an AP and to be connected to a server via the AP, using the electronic device.

### BRIEF DESCRIPTION OF THE DRAWINGS

FIG. 1 is a diagram describing an electronic device in a network environment according to an embodiment of the disclosure.

FIG. 2 is a block diagram of an electronic device according to an embodiment of the disclosure.

FIG. 3 is a block diagram of a program module according to an embodiment of the disclosure.

FIG. 4 illustrates a system configuration including an electronic device, a device, an AP and a server according to an embodiment of the disclosure;

FIG. 5 illustrates a system configuration in which a plurality of devices in the vicinity of an electronic device are registered in a server using identification (ID) information of an AP transmitted from the electronic device, according to an embodiment of the disclosure.

FIG. 6 illustrates an example of a GUI screen for updating AP information of a device disconnected from an existing AP in an electronic device according to an embodiment of the disclosure.

FIG. 7 is a flowchart of a process of connecting a device to a first server using AP information stored in an electronic device according to an embodiment of the disclosure.

FIG. 8 is a flowchart of a process in which a device disconnected from a first server is connected to a first server using new AP information stored in an electronic device according to an embodiment of the disclosure.

FIG. 9 is a flowchart of a method of searching for devices in the vicinity and transmitting information for communication connection with a found device in an electronic device according to an embodiment of the disclosure.

### DETAILED DESCRIPTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar components may be marked by similar reference numerals. The terms of a singular form may include plural forms unless otherwise specified. In this disclosure, the expressions “A or B”, “at least one of A or/and B”, or “one or more of A or/and B”, and the like may include any and all combinations of one or more of the associated listed items. The terms, such as “first”, “second”, and the like may be used to refer to various components regardless of the order and/or the priority and to distinguish the relevant components from other components, but do not limit the components. When an component (e.g., a first component) is referred to as being “(operatively or communicatively) coupled with/to” or “connected to” another component (e.g., a second component), the component may be directly coupled with/to or connected to the other component or an intervening component (e.g., a third component) may be present.

According to the situation, the expression “configured to” used in this disclosure may be used as, for example, the expression “suitable for”, “having the capacity to”, “adapted to”, “made to”, “capable of”, or “designed to” in hardware or software. The expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

An electronic device according to various embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, medical devices, cameras, or wearable devices.

According to various embodiments, the peripheral device may include at least one of televisions (TVs), digital versatile disc (DVD) players, audios, refrigerators, air conditioners, cleaners, ovens, microwave ovens, washing machines, air cleaners, set-top boxes, home automation control panels, security control panels, media boxes (e.g., Samsung HomeSync™, Apple TV™, or Google TV™), game consoles (e.g., Xbox™ or PlayStation™) electronic dictionaries, electronic keys, camcorders, electronic picture frames, and the like.

According to another embodiment, the peripheral device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MM), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, drones, automatic teller's machines (ATMs), points of sales (POSs) of stores, or internet of things (e.g., light bulbs, various sensors, sprinkler devices, fire alarms, thermostats, street lamps, toasters, exercise equipment, hot water tanks, heaters, boilers, and the like). According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be a flexible electronic device or a combination of two or more above-described devices. Furthermore, an electronic device according to an embodiment of this disclosure may not be limited to the above-described electronic devices.

In this disclosure, the term “user” may refer to a person who uses an electronic device or may refer to a device (e.g., an artificial intelligence electronic device) that uses the electronic device.

In the disclosure, an electronic device and a peripheral device are relative concepts defined according to an operation to be performed. For example, even in the case of mobile terminals of the same kind, a first mobile terminal that sets up connection with an AP may be understood as an electronic device, and a second mobile terminal connected to the AP through the first mobile terminal may be understood as a peripheral device. Electronic devices and peripheral devices may collectively be referred to simply as “devices”. In other words, unless otherwise specified, the description of the electronic device may be applied to peripheral devices, and vice versa.

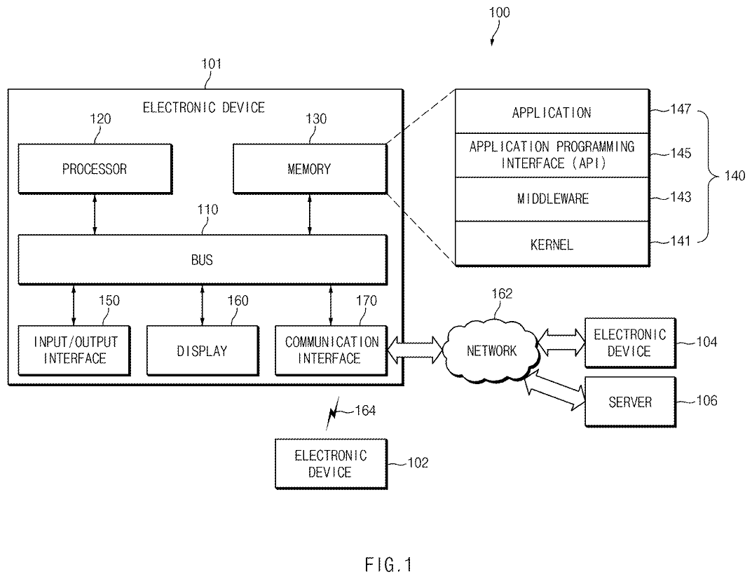

FIG. 1 illustrates an electronic device in a network environment according to various embodiments.

An electronic device 101 may include a bus 110, a processor 120, a memory 130, an input/output interface 150, a display 160, and a communication interface 170. According to an embodiment, the electronic device 101 may not include at least one of the above-described components or may further include other component(s). The bus 110 may interconnect the above-described components 110 to 170 and may include a circuit for delivering communications (e.g., a control message and/or data) among the above-described components. The processor 120 may include one or more of a central processing unit (CPU), an application processor (AP), or a communication processor (CP). For example, the processor 120 may perform an arithmetic operation or data processing associated with control and/or communication of at least other components of the electronic device 101.

The memory 130 may include a volatile and/or nonvolatile memory. For example, the memory 130 may store instructions or data associated with at least one other component(s) of the electronic device 101. According to an embodiment, the memory 130 may store software and/or a program 140. The program 140 may include, for example, a kernel 141, a middleware 143, an application programming interface (API) 145, and/or an application program (or “an application”) 147. At least a part of the kernel 141, the middleware 143, or the API 145 may be referred to as an “operating system (OS)”. For example, the kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete components of the electronic device 101 so as to control or manage system resources.

The middleware 143 may perform, for example, a mediation role such that the API 145 or the application program 147 communicates with the kernel 141 to exchange data. Furthermore, the middleware 143 may process one or more task requests received from the application program 147 according to a priority. For example, the middleware 143 may assign the priority, which makes it possible to use a system resource (e.g., the bus 110, the processor 120, the memory 130, or the like) of the electronic device 101, to at least one of the application program 147 and may process the one or more task requests. The API 145 may be an interface through which the application program 147 controls a function provided by the kernel 141 or the middleware 143, and may include, for example, at least one interface or function (e.g., an instruction) for a file control, a window control, image processing, a character control, or the like. The input/output interface 150 may transmit an instruction or data input from a user or another external device, to other component(s) of the electronic device 101 or may output an instruction or data, received from other component(s) of the electronic device 101, to a user or another external device.

The display 160 may include, for example, a liquid crystal display (LCD), a light-emitting diode (LED) display, an organic LED (OLED) display, a microelectromechanical systems (MEMS) display, or an electronic paper display. The display 160 may display, for example, various contents (e.g., a text, an image, a video, an icon, a symbol, and the like) to a user. The display 160 may include a touch screen and may receive, for example, a touch, gesture, proximity, or hovering input using an electronic pen or a part of a user's body. For example, the communication interface 170 may establish communication between the electronic device 101 and an external device (e.g., the first electronic device 102, the second electronic device 104, or the server 106). For example, the communication interface 170 may be connected to the network 162 over wireless communication or wired communication to communicate with the external device (e.g., the second electronic device 104 or the server 106).

For example, the wireless communication may include cellular communication using at least one of long-term evolution (LTE), LTE Advanced (LTE-A), Code Division Multiple Access (CDMA), Wideband CDMA (WCDMA), Universal Mobile Telecommunications System (UMTS), Wireless Broadband (WiBro), Global System for Mobile Communications (GSM), or the like. The wireless communication may include at least one of wireless fidelity (Wi-Fi), Bluetooth, Bluetooth low energy (BLE), Zigbee, near field communication (NFC), magnetic stripe transmission (MST), radio frequency (RF), a body area network, or the like. According to an embodiment, the wireless communication may include GNSS. The GNSS may be one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”). Hereinafter, in this disclosure, “GPS” and “GNSS” may be interchangeably used. The wired communication may include at least one of, for example, a universal serial bus (USB), a high definition multimedia interface (HDMI), a recommended standard-232 (RS-232), powerline communication, a plain old telephone service (POTS), or the like. The network 162 may include at least one of telecommunications networks, for example, a computer network (e.g., LAN or WAN), an Internet, or a telephone network.

Each of the first and second external electronic devices 102 and 104 may be a device of which the type is different from or the same as that of the electronic device 101. According to various embodiments, all or a portion of operations that the electronic device 101 will perform may be executed by another or plural electronic devices (e.g., the electronic device 102 or 104 or the server 106). According to an embodiment, in the case where the electronic device 101 executes any function or service automatically or in response to a request, the electronic device 101 may not perform the function or the service internally, but, alternatively additionally, it may request at least a portion of a function associated with the electronic device 101 at other electronic device (e.g., the electronic device 102 or 104 or the server 106). The other electronic device (e.g., the electronic device 102 or 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

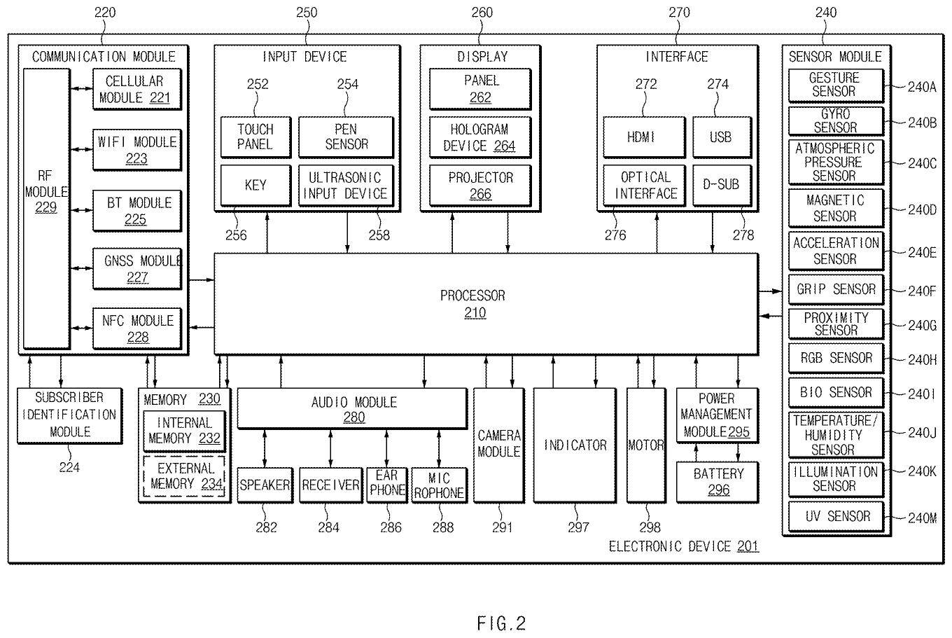

FIG. 2 illustrates a block diagram of an electronic device, according to an embodiment.

An electronic device 201 may include, for example, all or a part of the electronic device 101 illustrated in FIG. 1. The electronic device 201 may include one or more processors (e.g., an application processor (AP)) 210, a communication module 220, a subscriber identification module 224, a memory 230, a sensor module 240, an input device 250, a display 260, an interface 270, an audio module 280, a camera module 291, a power management module 295, a battery 296, an indicator 297, and a motor 298. The processor 210 may drive, for example, an operating system (OS) or an application to control a plurality of hardware or software components connected to the processor 210 and may process and compute a variety of data. For example, the processor 210 may be implemented with a System on Chip (SoC). According to an embodiment, the processor 210 may further include a graphic processing unit (GPU) and/or an image signal processor. The processor 210 may include at least a part (e.g., a cellular module 221) of components illustrated in FIG. 2. The processor 210 may load a command or data, which is received from at least one of other components (e.g., a nonvolatile memory), into a volatile memory and process the loaded instruction or data. The processor 210 may store result data in the nonvolatile memory.

The communication module 220 may be configured the same as or similar to the communication interface 170 of FIG. 1. The communication module 220 may include the cellular module 221, a Wi-Fi module 223, a Bluetooth (BT) module 225, a GNSS module 227, a near field communication (NFC) module 228, and a radio frequency (RF) module 229. The cellular module 221 may provide, for example, voice communication, video communication, a character service, an Internet service, or the like over a communication network. According to an embodiment, the cellular module 221 may perform discrimination and authentication of the electronic device 201 within a communication network by using the subscriber identification module (e.g., a SIM card) 224. According to an embodiment, the cellular module 221 may perform at least a portion of functions that the processor 210 provides. According to an embodiment, the cellular module 221 may include a communication processor (CP). According to an embodiment, at least a part (e.g., two or more) of the cellular module 221, the Wi-Fi module 223, the BT module 225, the GNSS module 227, or the NFC module 228 may be included within one Integrated Circuit (IC) or an IC package. For example, the RF module 229 may transmit and receive a communication signal (e.g., an RF signal). For example, the RF module 229 may include a transceiver, a power amplifier module (PAM), a frequency filter, a low noise amplifier (LNA), an antenna, or the like. According to another embodiment, at least one of the cellular module 221, the Wi-Fi module 223, the BT module 225, the GNSS module 227, or the NFC module 228 may transmit and receive an RF signal through a separate RF module. The subscriber identification module 224 may include, for example, a card and/or embedded SIM that includes a subscriber identification module and may include unique identify information (e.g., integrated circuit card identifier (ICCID)) or subscriber information (e.g., international mobile subscriber identity (IMSI)).

The memory 230 (e.g., the memory 130) may include an internal memory 232 or an external memory 234. For example, the internal memory 232 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, or a solid state drive (SSD). The external memory 234 may include a flash drive such as compact flash (CF), secure digital (SD), micro secure digital (Micro-SD), mini secure digital (Mini-SD), extreme digital (xD), a multimedia card (MMC), a memory stick, or the like. The external memory 234 may be operatively and/or physically connected to the electronic device 201 through various interfaces.

The sensor module 240 may measure, for example, a physical quantity or may detect an operation state of the electronic device 201. The sensor module 240 may convert the measured or detected information to an electric signal. For example, the sensor module 240 may include at least one of a gesture sensor 240A, a gyro sensor 240B, a barometric pressure sensor 240C, a magnetic sensor 240D, an acceleration sensor 240E, a grip sensor 240F, the proximity sensor 240G, a color sensor 240H (e.g., red, green, blue (RGB) sensor), a biometric sensor 2401, a temperature/humidity sensor 2401, an illuminance sensor 240K, or an UV sensor 240M. Although not illustrated, additionally or alternatively, the sensor module 240 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one or more sensors included therein. According to an embodiment, the electronic device 201 may further include a processor that is a part of the processor 210 or independent of the processor 210 and is configured to control the sensor module 240. The processor may control the sensor module 240 while the processor 210 remains at a sleep state.

The input device 250 may include, for example, a touch panel 252, a (digital) pen sensor 254, a key 256, or an ultrasonic input unit 258. For example, the touch panel 252 may use at least one of capacitive, resistive, infrared and ultrasonic detecting methods. Also, the touch panel 252 may further include a control circuit. The touch panel 252 may further include a tactile layer to provide a tactile reaction to a user. The (digital) pen sensor 254 may be, for example, a part of a touch panel or may include an additional sheet for recognition. The key 256 may include, for example, a physical button, an optical key, or a keypad. The ultrasonic input device 258 may detect (or sense) an ultrasonic signal, which is generated from an input device, through a microphone (e.g., a microphone 288) and may check data corresponding to the detected ultrasonic signal.

The display 260 (e.g., the display 160) may include a panel 262, a hologram device 264, a projector 266, and/or a control circuit for controlling the panel 262, the hologram device 264, or the projector 266. The panel 262 may be implemented, for example, to be flexible, transparent or wearable. The panel 262 and the touch panel 252 may be integrated into a single module. According to an embodiment, the panel 262 may include a pressure sensor (or force sensor) that measures the intensity of touch pressure by a user. The pressure sensor may be implemented integrally with the touch panel 252, or may be implemented as at least one sensor separately from the touch panel 252. The hologram device 264 may display a stereoscopic image in a space using a light interference phenomenon. The projector 266 may project light onto a screen so as to display an image. For example, the screen may be arranged in the inside or the outside of the electronic device 201. The interface 270 may include, for example, a high-definition multimedia interface (HDMI) 272, a universal serial bus (USB) 274, an optical interface 276, or a D-subminiature (D-sub) 278. The interface 270 may be included, for example, in the communication interface 170 illustrated in FIG. 1. Additionally or alternatively, the interface 270 may include, for example, a mobile high definition link (MHL) interface, a SD card/multi-media card (MMC) interface, or an infrared data association (IrDA) standard interface.

The audio module 280 may convert a sound and an electric signal in dual directions. At least a component of the audio module 280 may be included, for example, in the input/output interface 150 illustrated in FIG. 1. The audio module 280 may process, for example, sound information that is input or output through a speaker 282, a receiver 284, an earphone 286, or the microphone 288. For example, the camera module 291 may shoot a still image or a video. According to an embodiment, the camera module 291 may include at least one or more image sensors (e.g., a front sensor or a rear sensor), a lens, an image signal processor (ISP), or a flash (e.g., an LED or a xenon lamp). The power management module 295 may manage, for example, power of the electronic device 201. According to an embodiment, a power management integrated circuit (PMIC), a charger IC, or a battery or fuel gauge may be included in the power management module 295. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 296 and a voltage, current or temperature thereof while the battery is charged. The battery 296 may include, for example, a rechargeable battery and/or a solar battery.

The indicator 297 may display a specific state of the electronic device 201 or a part thereof (e.g., the processor 210), such as a booting state, a message state, a charging state, and the like. The motor 298 may convert an electrical signal into a mechanical vibration and may generate the following effects: vibration, haptic, and the like. The electronic device 201 may include a processing device (e.g., a GPU) for supporting a mobile TV. The processing device for supporting the mobile TV may process media data according to the standards of digital multimedia broadcasting (DMB), digital video broadcasting (DVB), MediaFLO™, or the like. Each of the above-mentioned components of the electronic device according to various embodiments of the disclosure may be configured with one or more components, and the names of the components may be changed according to the type of the electronic device. In various embodiments, some components of the electronic device (e.g., the electronic device 201) may be omitted or other additional components may be added. Furthermore, some of the components of the electronic device may be combined with each other so as to form one entity, so that the functions of the components may be performed in the same manner as before the combination.

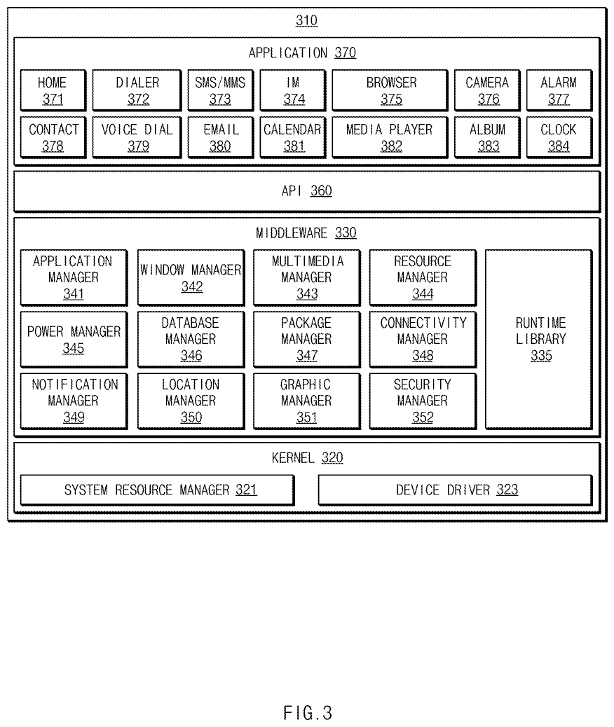

FIG. 3 illustrates a block diagram of a program module, according to an embodiment.

According to an embodiment, a program module 310 (e.g., the program 140) may include an operating system (OS) to control resources associated with an electronic device (e.g., the electronic device 101), and/or diverse applications (e.g., the application program 147) driven on the OS. The OS may be, for example, Android™, iOS™, Windows™, Symbian™, Tizen™, or Bada™. Referring to FIG. 3, the program module 310 may include a kernel 320 (e.g., the kernel 141), a middleware 330 (e.g., the middleware 143), an application programming interface (API) 360 (e.g., the API 145), and/or an application 370 (e.g., the application program 147). At least a portion of the program module 310 may be preloaded on an electronic device or may be downloadable from an external electronic device (e.g., the first electronic device 102, the second electronic device 104, the server 106, or the like).

The kernel 320 (e.g., the kernel 141) may include, for example, a system resource manager 321 or a device driver 323. The system resource manager 321 may control, allocate, or retrieve system resources. According to an embodiment, the system resource manager 321 may include a process managing unit, a memory managing unit, a file system managing unit, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver. The middleware 330 may provide, for example, a function that the application 370 needs in common, or may provide diverse functions to the application 370 through the API 360 to allow the application 370 to efficiently use limited system resources of the electronic device. According to an embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include, for example, a library module that is used by a compiler to add a new function through a programming language while the application 370 is being executed. The runtime library 335 may perform input/output management, memory management, or capacities about arithmetic functions. The application manager 341 may manage, for example, a life cycle of at least one application of the application 370. The window manager 342 may manage a graphic user interface (GUI) resource that is used in a screen. The multimedia manager 343 may identify a format necessary for playing diverse media files, and may perform encoding or decoding of media files by using a codec suitable for the format. The resource manager 344 may manage resources such as a memory space or source code of the application 370. The power manager 345 may manage a battery or power, and may provide power information for an operation of an electronic device. According to an embodiment, the power manager 345 may operate with a basic input/output system (BIOS). The database manager 346 may generate, search for, or modify database that is to be used in the application 370. The package manager 347 may install or update an application that is distributed in the form of package file.

The connectivity manager 348 may manage, for example, wireless connection. The notification manager 349 may provide an event, for example, arrival message, appointment, or proximity notification to a user. For example, the location manager 350 may manage location information about an electronic device. The graphic manager 351 may manage a graphic effect that is provided to a user, or manage a user interface relevant thereto. The security manager 352 may provide, for example, system security or user authentication. According to an embodiment, the middleware 330 may include a telephony manager for managing a voice or video call function of the electronic device or a middleware module that combines diverse functions of the above-described components. According to an embodiment, the middleware 330 may provide a module specialized to each OS kind to provide differentiated functions. Additionally, the middleware 330 may dynamically remove a part of the preexisting components or may add new components thereto. The API 360 may be, for example, a set of programming functions and may be provided with a configuration that is variable depending on an OS. For example, in the case where an OS is the android or the iOS, it may provide one API set per platform. In the case where an OS is the tizen, it may provide two or more API sets per platform.

The application 370 may include, for example, applications such as a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, a watch 384, health care (e.g., measuring an exercise quantity, blood sugar, or the like) or offering of environment information (e.g., information of barometric pressure, humidity, temperature, or the like). According to an embodiment, the application 370 may include an information exchanging application to support information exchange between an electronic device and an external electronic device. The information exchanging application may include, for example, a notification relay application for transmitting specific information to an external electronic device, or a device management application for managing the external electronic device. For example, the notification relay application may include a function of transmitting notification information, which arise from other applications, to an external electronic device or may receive, for example, notification information from an external electronic device and provide the notification information to a user. The device management application may install, delete, or update for example, a function (e.g., turn-on/turn-off of an external electronic device itself (or a part of components) or adjustment of brightness (or resolution) of a display) of the external electronic device which communicates with the electronic device, and an application running in the external electronic device. According to an embodiment, the application 370 may include an application (e.g., a health care application of a mobile medical device) that is assigned in accordance with an attribute of an external electronic device. According to an embodiment, the application 370 may include an application that is received from an external electronic device. At least a portion of the program module 310 may be implemented by software, firmware, hardware (e.g., the processor 210), or a combination (e.g., execution) of two or more thereof, and may include modules, programs, routines, sets of instructions, processes, or the like for performing one or more functions.

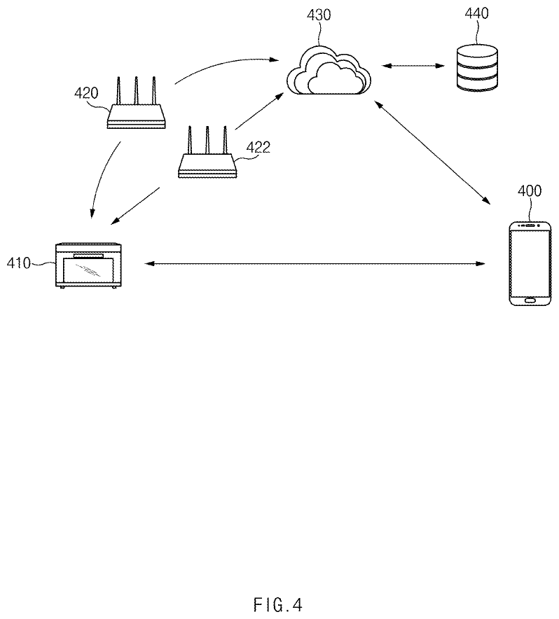

FIG. 4 illustrates a system configuration including an electronic device, a peripheral device, an AP and a server according to an embodiment of the disclosure.

Referring to FIG. 4, an electronic device 400, a peripheral device 410, access points (AP) 420 and 422, a first server 430, and a second server 440 are illustrated.

The peripheral device 410 may be an Internet Of Things (IoT) device and may include a short-range communication module such as Wi-Fi or Bluetooth. In one embodiment, the peripheral device 410 may include only one communication channel.

The peripheral device 410 may be connected to the access point 420 and may be connected to the first server 430 via the access point (AP) 420. For convenience of description, the access point will be abbreviated as AP.

The peripheral device 410 may be, for example, a home appliance in the home, such as a microwave oven, a refrigerator, a washing machine, or an air conditioner.

The peripheral device 410 may include a communication module in communication with the electronic device 400 and the AP 420 and a processor electrically connected to the communication module. The processor may receive identification (ID) information of the AP 420 transmitted by the electronic device 400, be connected to the AP 420 based on the identification (ID) information of the AP 420, and transmit the identification (ID) Information of the peripheral device 410 to the AP 420.

The peripheral device 410 may operate in an AP mode when a power supply is initially turned on. When the peripheral device 410 operates in the AP mode, the peripheral device 410 may broadcast its identification information such that other peripheral devices or the electronic device 400 are able to obtain the identification information. The identification (ID) information may include, for example, an SSID. The identification (ID) information may also include an IP address, a MAC address, a model name, and/or a peripheral device name of the peripheral device 410.

Meanwhile, the peripheral device 410 may not include a display device for displaying information, which may make it difficult for a user to directly operate the peripheral device 410 and connect it to the AP 420.

The peripheral device 410 may need to have the ID information (e.g., SSID) of the AP 420 so as for the peripheral device 410 to be connected to the AP 420.

The peripheral device 410 may receive account information for connection to an account server from the electronic device 400 and may be connected to the first server 430 through the AP 420 using the account information.

The AP 420 and the AP 422 may be connected to the first server 430. When the peripheral device 410 is connected to the AP 420, the peripheral device 410 may be connected to the first server 430 via the AP 420. The peripheral device 410 may also be registered in a user account of the first server 430. The peripheral device 410 may need to have user account information to be registered in the user account.

The electronic device 400 may be, for example, a user's smartphone, and may be connected to the AP 420 or 422 via a communication module, or directly connected to the first server 430 via the same or another communication module. When the electronic device 400 is connected to the AP 420 or 422, the electronic device 400 may be connected to the first server 430 via the AP 420 or 422.

When the electronic device 400 is connected to the AP 420, the electronic device 400 may receive an SSID and/or a password from the AP 420 and store the same in a memory.

The first server 430 may be a server that manages peripheral devices in the home (e.g., customer electronics (CE), home electronics (HE), and IoT devices). The first server 430 may store identification (ID) information of the peripheral device 410 connected to the AP 420 and control the peripheral device 410. For example, when a microwave oven is connected to the first server 430, the first server 430 may control a cooking time and a cooking method of the microwave oven. When an air conditioner is connected to the first server 430, the first server 430 may control an operation time and a temperature of the air conditioner.

Meanwhile, the first server 430 may create a user account to manage a plurality of peripheral devices 410, 412, and 414 in the home. The account information may be needed so as for the peripheral device 410 to access or register a user account. The account information may include an identification (ID) and a password.

The second server 440 may receive the identification information of the peripheral device 410 connected to the first server 430 from the first server 430 and include a database that generates and manages a key code corresponding to the peripheral device 410. The functions of the second server 440 may be included in the first server 430 according to an embodiment.

In the following description, a process of registering a new peripheral device 410 in the first server 430 using the electronic device 400 according to an embodiment of the disclosure will be described.

When the user first turns on a power supply after purchasing the peripheral device 410, the peripheral device 410 may operate in the AP mode. The peripheral device 410 may broadcast the identification (ID) information of the peripheral device 410 toward the periphery while operating in the AP mode.

The electronic device 400 may receive identification (ID) information transmitted by the peripheral device 410 and connect to the peripheral device 410 by selecting the peripheral device 410 through a screen. The electronic device 400 may store the identification information (e.g., SSID) of the previously-connected AP 420 in the memory and transmit the IP information of the AP 420 to the peripheral device 410.

The user may also enter account information of the user (e.g., the identification (ID) and password of the user) via the electronic device 400 to register the peripheral device 410 in the user account of the first server 430. The electronic device 400 may transmit the account information of the user input from the user to the peripheral device 410.

The peripheral device 410 may connect to the AP 420 using the identification (ID) information of the AP 420 received from the electronic device 400 and register the peripheral device 410 in the user account by connecting to the first server 430 using the user account information.

When the peripheral device 410 is registered in the first server 430, the identification information of the peripheral device 410 may be stored in the memory of the first server 430.

The first server 430 may transmit the identification (ID) information of the peripheral device 410 stored in a memory to the second server 440 and the second server 440 may create a key code corresponding to the peripheral device 410. The key code may include identification (ID) information of the peripheral device 410, such as an SSID and/or a password.

The first server 430 may transmit the key code to the peripheral device 410 and the peripheral device 410 may receive and store the key code in a memory.

In the following description, there will be given a process of reconnecting to the first server 430 in the peripheral device 410 in a state where the AP 420 fails or disconnection occurs due a communication error after the peripheral device 410 has been connected to the first server 430 via the AP 420.

The description will be given under the assumption that the AP 420 is changed to the AP 422 and the identification (ID) information of the AP 422 is stored in the memory in a state where the electronic device 400 has been already connected to the AP 422 for convenience of the description.

As the AP 420 is changed to another AP 422, the peripheral device 410 may be disconnected from the first server 430. When it is determined that the first server 430 is disconnected from the peripheral device 410, the first server 430 may transmit information indicating that the connection with the peripheral device 410 is broken to the electronic device 400.

The electronic device 400 may receive, from the first server 430, information indicating that the peripheral device 410 is disconnected from the first server 430, and request the key code of the peripheral device 410 from the first server 430 based on the information. Specifically, the electronic device 400 may transmit, to the first server 430, the identification information (e.g., a bar code attached to the peripheral device 410, a serial number, a model name, the identification (ID) information, or the like). The first server 430 may request and receive a key code corresponding to the peripheral device 410 from the second server 440 using the identification information. The first server 430 may transmit the key code to the electronic device 400.

The electronic device 400 may operate in the AP mode when the key code is received. The key code may include the identification (ID) information (e.g., SSID and/or password) of the peripheral device 410. The electronic device 400 may broadcast the key code (e.g., the SSID of the peripheral device) corresponding to the peripheral device 410 while operating in the AP mode.

Meanwhile, when the peripheral device 410 is disconnected from the first server 430, the peripheral device 410 may search for an AP using the key code stored in the memory, and may be connected to the electronic device 400 operating in the AP mode.

When the peripheral device 410 is connected to the electronic device 400, the electronic device 400 may transmit, to the peripheral device 410, the identification (ID) information for the AP 422 stored in memory and account information for enabling access to a user account of the first server 430.

The peripheral device 410 may receive identification (ID) information and account information for the AP 422 to connect to the AP 422 and access the user account of the first server 430 using the account information.

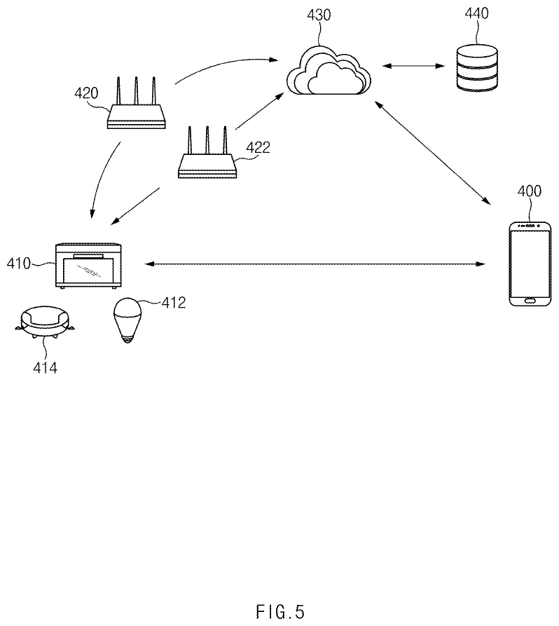

FIG. 5 illustrates a system configuration in which a plurality of peripheral devices in the vicinity of an electronic device are registered in a server using identification (ID) information of an AP transmitted from the electronic device, according to an embodiment of the disclosure.

Referring to FIG. 5, the electronic device 400, the peripheral devices 410, 412 and 414, the APs 420 and 422, the first server 430 and the second server 440 are shown.

For convenience of description, the AP 420 is assumed to be the AP that has been initially connected to the peripheral devices 410, 412, and 414. It is assumed that the peripheral device 410 is a microwave oven, the peripheral device 412 is a smart bulb, and the peripheral device 414 is a robot cleaner.

The microwave oven 410, the smart bulb 412, and the robot cleaner 414 may be registered in the first server 430 via the AP 420 through the process described with reference to FIG. 4.

Meanwhile, the microwave oven 410, the smart bulb 412, and the robot cleaner 414 may be grouped into the same group, and the same group ID may be assigned when registered in the user account of the first server 430.

The first server 430 may transmit identification information of the microwave oven 410, identification information of the smart bulb 412, identification information of the robot cleaner 414 and the group ID to the second server 440.

The second server 440 may generate a key code corresponding to the microwave oven 410 using the identification (ID) information and the group ID of the microwave oven 410 and transmit the generated key code to the first server 430. The first server 430 may transmit the key code corresponding to the microwave oven 410 to the microwave oven 410 via the AP 420. The microwave oven 410 may store the received key code in a memory.

The second server 440 may generate a key code corresponding to the smart bulb 412 using the identification (ID) information and the group ID of the smart bulb 412 and transmit the generated key code to the first server 430. The first server 430 may transmit the key code corresponding to the smart bulb 412 to the smart bulb 412 via the AP 420. The smart bulb 412 may store the received key code in a memory.

The second server 440 may generate a key code corresponding to the robot cleaner 414 using the identification (ID) information and the group ID of the robot cleaner 414 and transmit the generated key code to the first server 430. The first server 430 may transmit the key code corresponding to the robot cleaner 414 to the robot cleaner 414 via the AP 420. The robot cleaner 414 may store the received key code in a memory.

The key code of the microwave oven 410, the key code of the smart bulb 412, and the key code of the robot cleaner 414 may include the same group ID.

When the AP 420 is changed to the AP 422, the microwave oven 410, the smart bulb 412, and the robot cleaner 414 may be disconnected from the first server 430.

The first server 430 may transmit information to the electronic device 400 indicating that the connection with the microwave oven 410, the smart bulb 412, and the robot cleaner 414 has been broken.

The electronic device 400 may request the key code of the microwave oven 410, the smart bulb 412, or the robot cleaner 414 from the first server 430 for reconnection with the microwave oven 410, the smart bulb 412 or the robot cleaner 414.

The electronic device 400 may broadcast the group ID included in the key code while operating in the AP mode.

The microwave oven 410 is connected to the electronic device 400 operating in the AP mode using a key code (e.g., a group ID) stored in the memory as the connection to the first server 430 is disconnected, and the electronic device 400 may transmit the identification (ID) information and account information of the AP 422 to the microwave oven 410. The microwave oven 410 may be connected to the AP 422 using the identification information and the account information received from the electronic device 400 and may be connected to the first server 430 via the AP 422.

Likewise, the smart bulb 412 and the robot cleaner 414 may be connected to the first server 430 in the same manner as described above.

Meanwhile, as the electronic device 400 broadcasts the group ID, the microwave oven 410, the smart bulb 412, and the robot cleaner 414 having the same group ID may be collectively connected to the electronic device 400.

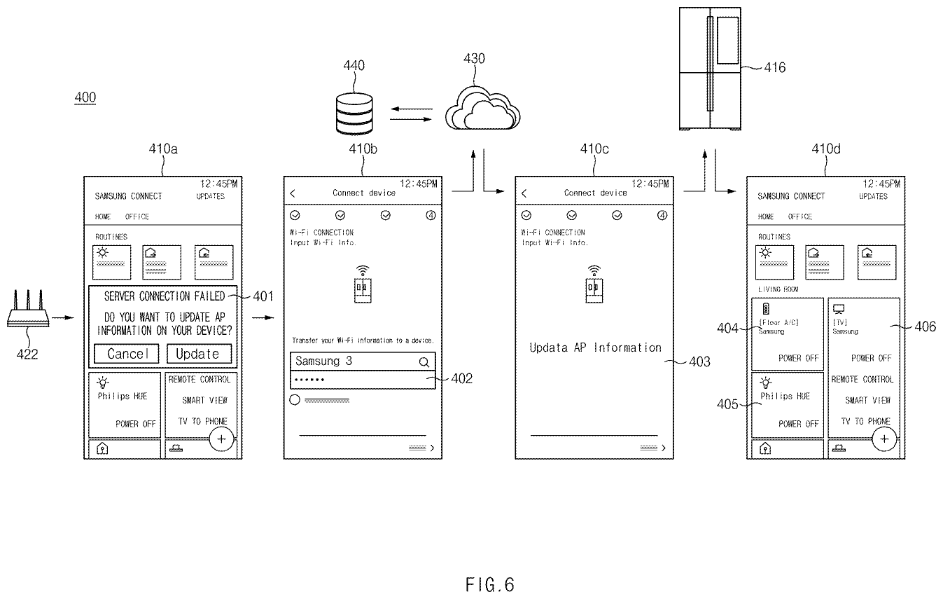

FIG. 6 illustrates an example of a GUI screen for updating AP information of a peripheral device disconnected from an existing AP in an electronic device according to an embodiment of the disclosure.

Referring to FIG. 6, screens 401, 402, 403 and 404 of an electronic device, the AP 422, the first server 430, the second server 440 and a peripheral device 416 are shown.

For convenience of description, it is assumed that a new AP 422 and the electronic device 400 are connected to each other and that the electronic device 400 stores identification (ID) information of the new AP 422 in the memory.

As the existing AP (not illustrated) is changed to the new AP 422, the connection between the peripheral device 416 and the first server 430 may be broken and the first server 430 may transmit, to the electronic device 400, information indicating that the connection between the peripheral device 416 and the first server 430 is broken. The electronic device 400 may receive the information, display a list of peripheral devices disconnected from the first server 430 on a screen 410a based on the information, and display information indicating that the connection is broken and a pop-up window containing a query for whether to update the AP information. The electronic device 400 may receive a user input via the pop-up window.

When receiving a user input requesting update of the AP information, the electronic device 400 may display account information 402 (e.g., identification (ID) and password) that enables access to the first server 430 on a screen 410b.

The electronic device 400 may request a key code for the peripheral device 416 from the first server 430 and the first server 430 may receive the key code for the peripheral device 416 from the second server 440 and retransmit the same to the electronic device 400.

The electronic device 400 may receive the key code and may be connected to the peripheral device 416 based on the identification (ID) information for the peripheral device 416 included in the key code. A detailed description for a connection process is the same as that described above with reference to FIG. 4 and therefore, will be omitted.

The electronic device 400 may transmit identification (ID) information for the new AP 422 and account information to the peripheral device 416 after the electronic device 400 is connected to the peripheral device 416, and a message “update AP information”(403) may be displayed on a screen 410c.

The peripheral device 416 may connect to the new AP 422 and the first server 430 using the identification (ID) information for the new AP 422 and the account information received from the electronic device 400.

As the peripheral device 416 and the first server 430 are connected to each other, the list 404, 405, 406 of the peripheral device 416 connected to the first server 430 may be displayed on a screen 410d of the electronic device 400.

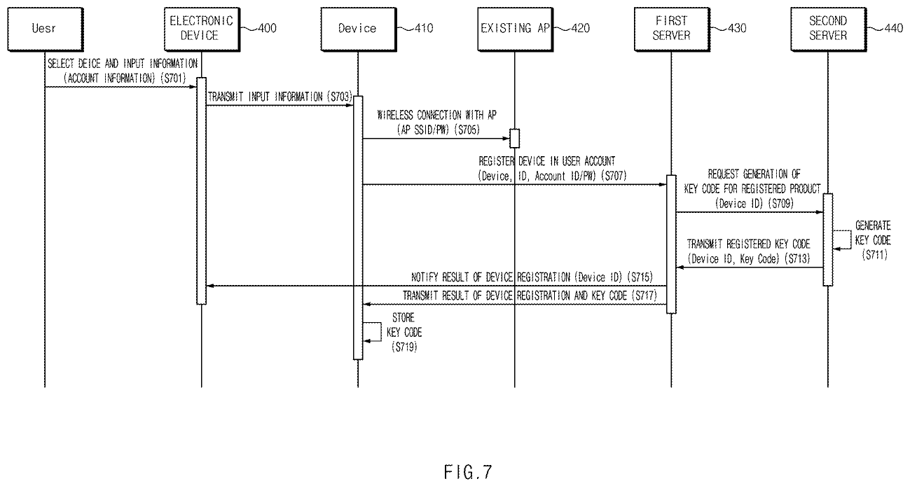

FIG. 7 is a flowchart of a process of connecting a peripheral device to a first server using AP information stored in an electronic device according to an embodiment of the disclosure.

Referring to FIG. 7, the electronic device 400 may receive a user input for inputting selection of a peripheral device and account information (S701). The account information may include information that enables access to the account of a user registered in the first server 430.

The electronic device 400 may transmit the input account information and the identification (ID) information of the AP 420 to the peripheral device 410 (S703). The identification (ID) information may include, for example, the SSID and password of the AP 420.

The peripheral device 410 may connect to the AP 420 using the identification (ID) information of the AP 420 (S705). The peripheral device 410 may be registered in the user account in the first server 430 through the AP 420 (S707). Specifically, the peripheral device 410 may be registered in the user account through the process of transmitting the identification (ID) information of the peripheral device 410 and the account information to the first server 430. The account information may include an ID and a password that enable access to the account.

The first server 430 may receive peripheral device identification (ID) information and account information from the peripheral device 410 and register the peripheral device 410 in the user account. The first server 430 may transmit the identification (ID) information of the peripheral device 410 to the second server 440 and request generation of a key code (S709). The second server 440 may generate a key code (S711), and transmit the identification (ID) information and the key code of the peripheral device 410 to the first server 430 (S713).

The first server 430 may transmit the identification (ID) information of the peripheral device 410 to the electronic device 400 to inform a registration result (S715). Also, the first server 430 may transmit the device registration result and the key code for the peripheral device 410 to the peripheral device 410 (S717). The peripheral device 410 may store the received key code in the memory (S719).

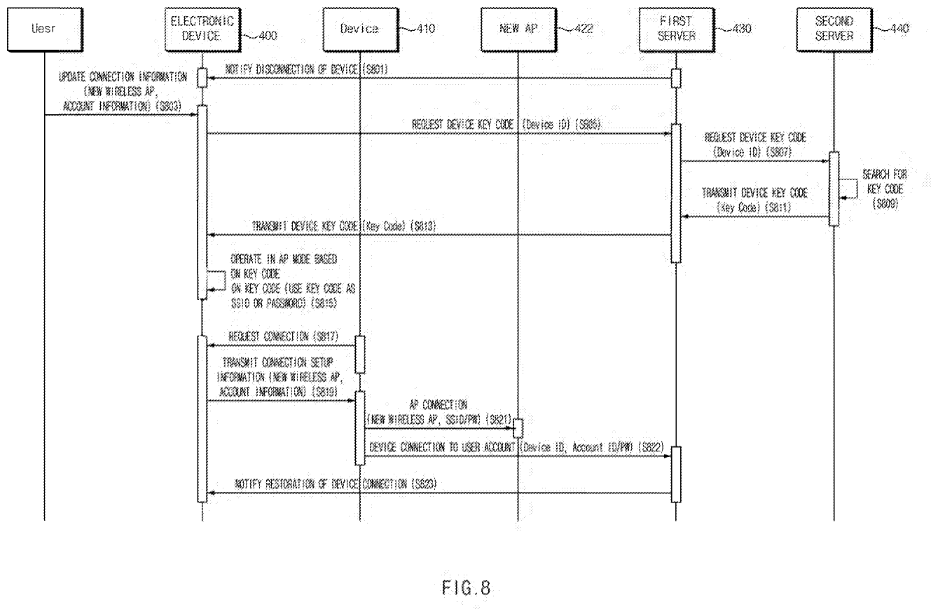

FIG. 8 is a flowchart of a process of connecting a peripheral device disconnected from a first server to a first server using new AP information stored in an electronic device according to an embodiment of the disclosure.

The electronic device 400 may receive information indicating that device connection is broken from the first server 430 (S801). The electronic device 400 may receive a user input for updating connection setup information between the AP 422 and the peripheral device 410 (S803).

The electronic device 400 may request the key code of the peripheral device 410 from the first server 430 based on the user input. Specifically, the electronic device 400 may transmit the identification (ID) information of the peripheral device 410 to the first server 430 (S805), and the first server 430 may request a key code corresponding to the peripheral device 410 from the second server 440 based on the identification information of the peripheral device 410 (S807).

The second server 440 may search for a key code corresponding to the received identification (ID) information of the peripheral device 410 (S809) and transmit the found key code to the first server 430 (S811).

The first server 430 may transmit the received key code to the electronic device 400 (S813).

The electronic device 400 may operate in the AP mode using the key code received from the first server 430 (S815). The electronic device 400 may broadcast the key code while operating in the AP mode. The key code may include identification (ID) information of the peripheral device 410 (e.g., the SSID and password of the peripheral device). The electronic device 400 may broadcast the key code using the SSID and the password, and the peripheral device 410 may request connection from the electronic device 400 using the key code stored in the memory (S817).

After the electronic device 400 is connected to the peripheral device 410, the electronic device 400 may transmit connection settings information to the peripheral device 410 (S819). Specifically, the electronic device 400 may transmit identification (ID) information of the new AP 422 and user account information of the first server 430 to the peripheral device 410.

The peripheral device 410 may connect to the new AP 422 using the identification (ID) information of the new AP 422 and the account information, which are received from the electronic device 400 (S821).

Also, the peripheral device 410 may access the user account of the first server 430 via the new AP 422 and may connect to the first server 430 (S822). The peripheral device 410 may transmit the identification (ID) information of the peripheral device 410 to the first server 430 after being connected to the first server 430.

When the peripheral device 410 is connected thereto, the first server 430 may transmit information indicating that the connection is restored to the electronic device 400 (S823).

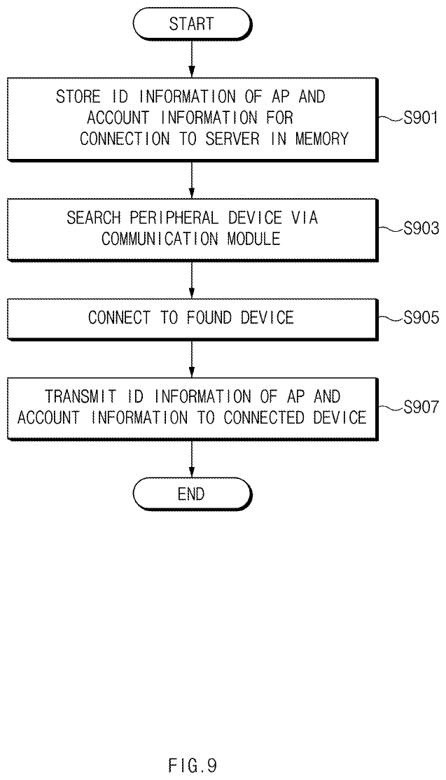

FIG. 9 is a flowchart of a method of searching for devices in the vicinity and transmitting information for communication connection to a found peripheral device in an electronic device according to an embodiment of the disclosure.

Referring to FIG. 9, the electronic device 400 may store identification information (ID) of an AP to which the electronic device 400 is connected and account information for enabling connection to a server in a memory (S901).

Specifically, the electronic device 400 may search for the AP, connect to the AP using the identification (ID) information (e.g., SSID and/or password) broadcasted by the AP, and then store the SSID and password of the AP in a memory. Depending on embodiments, the AP may not require a password. The electronic device 400 may be connected to the first server 430 via the AP or to the first server 430 via a remote communication module and may store account information for enabling access to the user account of the first server 430 in a memory. The account information may include an ID and a password for enabling access to the account of the first server 430.

The electronic device 400 may search for peripheral devices 410 through the communication module (S903).

The electronic device 400 may search for the identification information of the peripheral device 410 broadcast by the peripheral device 410 present around the electronic device 400. The identification (ID) information of the peripheral device 410 may include, for example, the SSID of the peripheral device 410 or the MAC address of the peripheral device.

The electronic device 400 may connect to the found peripheral device 410 (S905). For example, the electronic device 400 may identify the peripheral device 410 and connect to the peripheral device 410 using the SSID received from the peripheral device 410.

When the electronic device 400 connects to the peripheral device 410, the electronic device 400 may transmit identification information (ID) of the AP and account information stored in the memory to the connected peripheral device 410 (S907).

The peripheral device 410 may connect to the AP using the identification (ID) information, and may connect to the first server 430 via the AP. Also, the peripheral device 410 may access the user account of the first server 430 using the account information, and the first server 430 may register the peripheral device 410 in the user account.

The term “module” used in this disclosure may include a unit composed of hardware, software and firmware and may be interchangeably used with the terms “unit”, “logic”, “logical block”, “part” and “circuit”. The “module” may be an integrated part or may be a minimum unit for performing one or more functions or a part thereof. The “module” may be implemented mechanically or electronically and may include at least one of an application-specific IC (ASIC) chip, a field-programmable gate array (FPGA), and a programmable-logic device for performing some operations, which are known or will be developed. At least a part of an apparatus (e.g., modules or functions thereof) or a method (e.g., operations) according to various embodiments may be, for example, implemented by instructions stored in computer-readable storage media (e.g., the memory 130) in the form of a program module. The instruction, when executed by a processor (e.g., the processor 120), may cause the processor to perform a function corresponding to the instruction. A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and an internal memory. Also, the one or more instructions may contain a code made by a compiler or a code executable by an interpreter. A module or a program module according to various embodiments may include at least one of the above components, or a part of the above components may be omitted, or other components may be further included. Operations performed by a module, a program module, or other components according to various embodiments may be executed sequentially, in parallel, repeatedly, or in a heuristic method or some operations may be executed in different sequences or may be omitted. Alternatively, other operations may be added.

The disclosed embodiments may be implemented in a software program including instructions stored on a computer-readable storage media.

The computer may include an electronic device according to the disclosed embodiments, as a device capable of calling stored instructions from a storage media and performing operations according to the disclosed embodiments based on the called instructions.

The computer-readable storage media may be provided in the form of a non-transitory storage media. In the disclosure, “non-transitory” means that the storage media does not include a signal and is tangible, but does not distinguish whether data is permanently or temporarily stored in a storage media.

Further, the electronic device or method according to the disclosed embodiments may be provided to be included in a computer program product. The computer program product may be traded between a seller and a buyer as a product.

The computer program product may include a software program and a computer readable storage medium having stored thereon the software program. For example, the computer program product may be a software program product (e.g., a downloadable application) that is electronically distributed through an electronic device, a manufacturer of an electronic device, or an electronic marketplace (e.g., Google Play Store or App Store). For electronic distribution, at least a portion of the S/W program may be stored on a storage media or may be created temporarily. In this case, the storage media may be a server of a manufacturer, a server of an electronic market, or a storage media of a relay server for temporarily storing an SW program.

1. An electronic device comprising:
a communication module configured to perform communication with a server, a peripheral device, and an access point;
a memory configured to store identification information of the access point and account information for the server; and
a processor electrically connected to the communication module and the memory,
wherein the processor is configured to search for the peripheral device via the communication module, connect to the found peripheral device, and transmit the identification information of the access point and the account information to the connected peripheral device.

2. The electronic device of claim 1, wherein the processor is configured to receive information indicating that connection between the server and the peripheral device is broken, from the server, request a key code containing identification information of the peripheral device from the server based on the received information, receive the key code from the server, and broadcast the identification information of the peripheral device contained in the key code.

3. The electronic device of claim 1, wherein the identification information of the access point includes at least one of an SSID and a password of the access point.

4. The electronic device of claim 1, wherein the identification information of the peripheral device includes at least one of an SSID and a password of the peripheral device.

5. The electronic device of claim 2, wherein the electronic device uses the key code as an SSID and a password of the electronic device.

6. The electronic device of claim 5, wherein the processor is configured to connect to the peripheral device based on the key code and transmit identification information of a new access point different from the access point and the account information to the peripheral device.

7. A device comprising:
a communication module configured to communicate with an electronic device and an access point; and
a processor electrically connected to the communication module,
wherein the processor is configured to receive identification information of the access point from the electronic device, connect to the access point based on the identification information of the access point, and transmit identification information of the device to the access point.

8. The device of claim 7, wherein the processor is configured to receive account information from the electronic device, and connect to a server via the access point using the account information.

9. The device of claim 7, further comprising:
a memory electrically connected to the processor,
wherein the processor is configured to receive a key code containing the identification information of the device from the electronic device and store the key code in the memory.

10. A method for performing communication connection in an electronic device, the method comprising:
storing identification information of an access point and account information for connecting to a server in a memory of the electronic device;
searching for a peripheral device around the electronic device via a communication module of the electronic device;
connecting the electronic device to the found peripheral device; and
transmitting the identification information of the access point and the account information to the connected peripheral device.

11. The method of claim 10, further comprising:
receiving information indicating that connection with the peripheral device is broken from the server;
requesting a key code containing identification information of the peripheral device from the server based on the received information;
receiving the key code from the server; and
broadcasting the identification information of the peripheral device contained in the key code.

12. The method of claim 10, wherein the identification information of the access point includes at least one of an SSID and a password of the access point.

13. The method of claim 10, wherein the identification information of the peripheral device includes at least one of an SSID and a password of the peripheral device.

14. The method of claim 10, wherein the key code is used as an SSID or a password of the electronic device.

15. The method of claim 14, further comprising:
connecting to the peripheral device based on the key code and transmitting identification information of a new access point different from the access point and the account information to the peripheral device.
